(19) United States
(12) Patent Application Publication
(10) Pub. No.: US 2015/0065279 A1
(43) Pub. Date: Mar. 5, 2015

(54) Arrow Tip with Spiral Edges for Bowfishing

(71) Applicant: AMS, LLC., Stratford, WI (US)

(72) Inventor: Jack La See, Abbotsford, WI (US)

(21) Appl. No.: 14/470,316

(22) Filed: Aug. 27, 2014

Related U.S. Application Data
(60) Provisional application No. 61/870,986, filed on Aug. 28, 2013.

(51) Int. Cl. F42B 6/08; B23C 3/00

(52) U.S. Cl. CPC F42B 6/08; B23C 3/00
USPC 473/584; 409/132

(57) ABSTRACT

An arrow tip for use in bowfishing has helical faces. The arrow tip may be attached to an arrow adapter containing barbs, which may be released by partially releasing the arrow tip. The helical faces tend to cause the arrow tip to rotate in accordance with the direction of its threaded attachment point, helping to ensure that the arrow tip is securely attached to the arrow adapter.

### CROSS REFERENCE TO RELATED APPLICATION

This application claims priority from U.S. Provisional Patent Application Ser. No. 61/870,986, filed on Aug. 28, 2013, the contents of which are herein incorporated by reference in their entirety.

### BACKGROUND OF THE INVENTION

The present invention relates generally to arrows suitable for use with bowfishing and in particular to an arrow tip suitable for use in bowfishing.

Bowfishing is an archery technique using specialized bows and arrows for fishing. A bowfishing bow may have a lower draw weight than a standard bows as well as a constant draw to allow rapid and frequent shooting without tiring the archer. The bowfishing bow may have bowfishing line stored in a canister or reel attached to the bow. One end of the bowfishing line is attached to the arrow so that when the arrow is released, the line pays out allowing the arrow and fish to be retrieved by reeling the line in. A bowfishing reel suitable for use in this purpose is described in U.S. Pat. Nos. 4,383,516 and 6,634,350 by the inventor of the present invention and hereby incorporated, by reference. The line may be attached to the arrow using a slide that moves freely up and down the arrow shaft. Before the arrow is released, the slide may be positioned in front of the arrow rest and bowstring and may remain in front of the arrow rest as the arrow is released to reduce risk of entangling either the bow or the bowstring. Slides suitable for this purpose are described in U.S. Pat. No. 6,517,453 also by the inventor of the present invention and hereby incorporated by reference.

The arrows used for bowfishing are normally fashioned out of high-strength fiberglass or carbon fiber composites to better survive impact with a stony bottom of a lake or stream. For similar reasons, the arrow tips used for bowfishing are designed with the expectation that they may strike hard surfaces. A common arrow tip for bowfishing, provides a compact cylindrical body of hardened steel or the like having a pyramidal tip formed of 3-6 flat or hollow ground faces tapering to a point. The faces abut each other at sharp edges to provide a cutting action as the arrow tip passes into the fish.

The arrow tip may attach to the fiberglass arrow shaft by means of a threaded adapter, the latter providing an interface between the arrow tip and the arrow shaft. Generally the threaded adapter receives the arrow shaft in a blind bore in the rear of the threaded adapter.

The arrow shaft is held within the bore, for example, with epoxy or the like. An opposite end of the threaded adapter provides a threaded stud or socket that may engage a corresponding socket or stud on the arrow tip. This threaded connection allows damaged arrow tips to be readily replaced by unthreading the arrow tip from the threaded adapter and threading a new arrow tip in its place.

The threaded adapter may provide sidewardly extending barbs that help retain the fish when the arrow is retrieved. In some cases, the barbs are held extended by the presence of the arrow tip as attached to the threaded adapter. In these cases, the arrow tip may be unscrewed to allow the barbs to be retracted or reversed to assist in removing the fish from the arrow.

It will be understood that it is important that the arrow tip be readily removable for replacement when it is damaged and in some cases for a resetting of the barbs for extraction of the arrow from the fish. Yet the vibration of impact after repeated shots can cause the arrow tip to become unthreaded and lost.

### SUMMARY OF THE INVENTION

The present invention provides an arrow tip suitable for bowfishing having spiral cut faces and edges. In one embodiment, the spiral coordinates with the threaded engagement between the arrow tip and the adapter so that impact of the arrow tip against stones or the like and passage of the arrow tip through the water tend to tighten the arrow tip to prevent its loss.

Specifically one embodiment of the invention provides an arrow tip having a tip body with an outer wall extending about a central axis. A point is formed at a front end providing a tapering inward of the outer walls towards the central axis to an apex on the central axis, wherein the point is formed from a plurality of faces joined at circumferentially abutting edges, the faces and edges extending about the axis in a helical path. A threaded attachment at a rear end of the tip extends along the axis to receive a second threaded attachment on an arrow shaft to releasably attach the arrow tip to the arrow shaft by rotationally threading the threaded attachment on the second threaded attachment.

It is thus a feature of one embodiment of the invention to provide a substantially new form of sharpened point on an arrow.

The apex may be a point of convergence of the helical faces and edges.

It is thus a feature of at least one embodiment of the invention to provide an arrow tip that converges to a point for superior penetration.

The helical faces and helical edges may run counterclockwise with respect to the central axis of the tip body viewed from the front end.

It is thus a feature of at least one embodiment of the invention to provide a helical form that conforms to standard right-handed threads.

The faces may be hollow wound.

It is thus a feature of at least one embodiment of the invention to permit multiple faces while preserving relatively sharp edges that resist dulling.

The helical faces and helical edges may have a rotational sense relative to the threaded attachment tending to tighten the threaded attachment when the tip passes through a resisting material with the apex in a leading position.

It is another feature of at least one embodiment of this invention to provide an arrow tip with helical faces that tend to tighten the arrow tip onto the arrow shaft when the arrow tip strikes a surface.

The tip may be part of an arrow providing a linear shaft, a nock, an adapter, and at least one arrow barbs that are retained against some range of movement by the tip.

It is thus one feature of at least one embodiment of the invention to provide a tip that may be retained on the arrow with only finger tightening so that it may be loosened for release of the barbs and yet which will resist dislodgment when the arrow strikes water, fish, or a hard surface.

These particular features and advantages may apply to only some embodiments falling within the claims and thus do not define the scope of the invention.

### BRIEF DESCRIPTION OF THE DRAWINGS

FIG. 1 is an exploded, side elevational view of one embodiment of the arrow tip of the present invention as may be received on a barbed adapter attached to an arrow shaft:

FIGS. 2a and 2b are front and rear views of the arrow tip of FIG. 1 showing the spiral edges and spiral faces of the arrow tip and the threaded socket of the arrow tip;

FIG. 3 is a side elevational view of a machining apparatus for cutting spiral edges on the arrow tip;

FIG. 4 is a top plan view of the machining apparatus of FIG. 3;

FIGS. 5-8 are left elevational, front elevational, rear elevational, and right elevational views of the arrow tip FIG. 2.

### DETAILED DESCRIPTION OF THE INVENTION

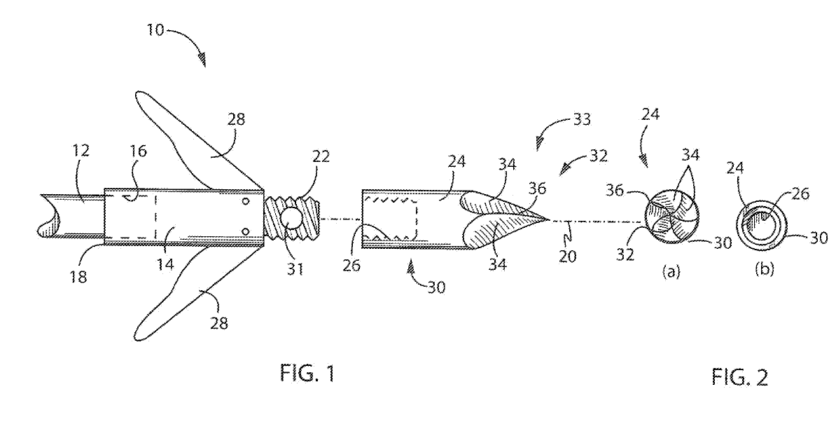

Referring now to FIG. 1, an arrow 10 for use with the present invention may provide for a carbon fiber or fiberglass arrow shaft 12 having a cylindrical cross-section, for example, 5/16 inch in diameter and approximately thirty-two inches long. A rear end of the arrow shaft 12 provides an arrow nock (not shown).

A front end of the arrow shaft 12 may attach to an adapter 14 by being received within a blind bore socket 16 of equal diameter in the adapter 14. The arrow shaft 12 may be held, within the socket 16 with epoxy 18 or the like.

The adapter 14 may provide a generally cylindrical metal body supporting the bore socket 16 at a rear end and extending along an axis 20 common to the arrow shaft 12 to terminate at a threaded boss 22 at a front end. An arrow tip 24 also extending generally along axis 20 and having a rearwardly-threaded bore 26 (also shown in FIG. 2b) may receive the threaded boss 22 to attach the arrow tip 24 to the adapter 14.

Pivoting barbs 28 may be attached to the adapter 14 to extend outwardly from the adapter 14 and back toward the arrow shaft 12. These barbs 28 help retain a fish on the arrow 10 after the arrow tip 24 and the adapter 14 and barbs 28 have passed through a fish. In order to remove the fish from the barbs 28, the barbs 28 may fold flat against the adapter 14 (when the arrow tip 24 has been loosened or removed from the threaded boss 22). When the arrow tip 24 is attached to the threaded boss 22, the barbs 28 may rest against the adapter 14 or may extend such that they are perpendicular to the adapter 14. However, the barbs 28 are prevented from extending further than perpendicular to the adapter 14 as long as the arrow tip 24 is attached to the threaded boss 22. An arrow and barb system suitable for the present invention is described in U.S. patent application Ser. No. 14/457,677 hereby incorporated by reference.

One or both of the threaded boss 22 and threaded bore 26 may be coated with a locking polymer 31 (or may incorporate a polymer insert) serving to lock, the threads together by deformation of the polymer 31 coupled with engaging of the threads of the threaded boss 22 and threaded bore 26 together. The locking polymer 31 allows the arrow tip 24 to better resist vibration induced when the arrow is shot, preventing unthreading from the threaded boss 22.

Referring now to FIGS. 1 and 2a, the arrow tip 24 provides for a cylindrical body 30 holding the threaded bore 26 and substantially equal in diameter to the adapter 14 as it attaches to the adapter 14. The cylindrical body 30 extends along the axis 20 to a forward tip 33 of the arrow tip 24, the latter of which is sharpened to a point 32. In particular, forward tip 33 is formed by a set of converging flat or hollow ground spiral faces 34 converging at the point 32. The spiral faces 34 abut along spiral edges 36. The spiral faces 34 and spiral edges 36 define a helical path running clockwise to the axis 20 from threaded bore 26 to point 32. In one embodiment five spiral faces 34 are provided (as depicted); however, the invention contemplates that between three and six spiral faces 34 and preferably at least five spiral faces 34 will normally be employed.

In one embodiment, the spiral faces 34 and spiral edges 36 curve in a counterclockwise direction as viewed from the point 32. In this case the thread of the threaded boss 22 may be a standard right-hand thread allowing the arrow tip 24 to tighten on the boss 22 with clockwise rotation of the arrow tip 24 as viewed from the point 32. It will be appreciated that as the arrow 10 flies, impacts with a stationary surface or passage through a medium such as water will cause the spiral faces 34 or spiral edges 36 to impart a clockwise torsion on the arrow tip 24 tending to tighten the arrow tip 24 onto the adapter 14.

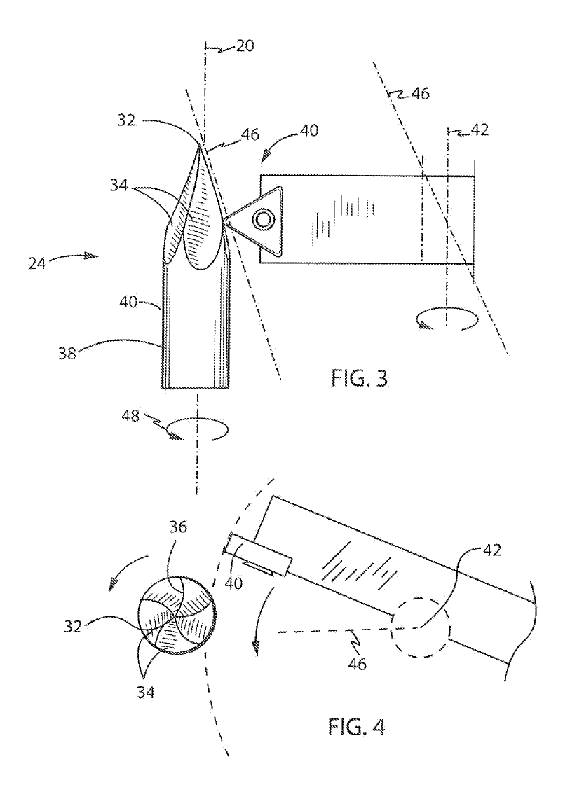

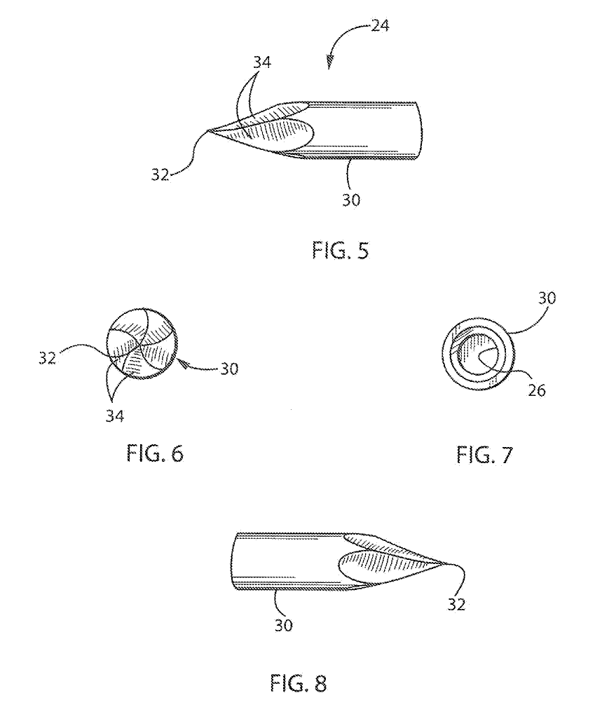

Referring now to FIG. 3, the arrow tip 24 may be fabricated from a stainless, titanium, or hardened steel cylinder 38 providing the cylindrical body 30 of the arrow tip 24. The cylinder may have a diameter of ¼″ to ⅝″, A cutter 40 is rotated about an axis 42 parallel to an axis 20 (along which the cylindrical body 30 extends) to cut the faces 34. The cutter 40 may be a carbide tool or the like, as shown, or the surface of a grinding wheel or other similar cutting mechanism. The radius of rotation of the cutter 40 in an arc about axis 42 defines a hollow cut of the faces 34. This hollow face sharpens the edges 36 beyond that which could be obtained by a simple faceting and provides edges that better resist dulling in the manner of a hollow ground knife-edge.

A pyramidal tapering of the faces 34 to the point 32 may be provided by an angled translation of the center of rotation of the cutter 40 along a taper path 46 following an angle of a taper of the arrow tip 24 while preserving a parallel alignment between the axis 42 and axis 20. A spiraling of the faces 34 is provided by slight rotation 48 of the cylindrical body 30 about axis 20 as the arc of the cutter 40 is translated along path 46. The amount of rotation 48 during the full translation along path 46 is preferably between two and 30 degrees. In order to provide the desired spiraling described above, the rotation 48 may be counterclockwise as the cutter 40 moves upward along path 46 as depicted in FIG. 3.

It will be appreciated that the spiral faces 34 are at all times circumscribed by the cylinder defined by the cylindrical body 30 and that the arrow tip 24 may be of unitary construction machined from a single cylinder of metal.

Certain terminology is used herein for purposes of reference only, and thus is not intended to be limiting. For example, terms such as “upper”, “lower”, “above”, and “below” refer to directions in the drawings to which reference is made. Terms such as “front”, “back”, “rear”, “bottom” and “side”, describe the orientation of portions of the component within a consistent but arbitrary frame of reference which is made clear by reference to the text and the associated drawings describing the component under discussion. Such terminology may include the words specifically mentioned above, derivatives thereof, and words of similar import. Similarly, the terms “first”, “second” and other such numerical terms referring to structures do not imply a sequence or order unless clearly indicated by the context.

When introducing elements or features of the present disclosure and the exemplary embodiments, the articles “a”, “an”. “the” and “said” are intended to mean that there are one or more of such elements or features. The terms “comprising”, “including” and “having” are intended to be inclusive and mean that there may be additional elements or features other than those specifically noted. It is further to be understood that the method steps, processes, and operations described herein are not to be construed as necessarily requiring their performance in the particular order discussed or illustrated, unless specifically identified as an order of performance. It is also to be understood that additional or alternative steps may be employed.

It is specifically intended that the present invention not be limited to the embodiments and illustrations contained herein and the claims should be understood to include modified forms of those embodiments including portions of the embodiments and combinations of elements of different embodiments as come within the scope of the following claims. All of the publications described herein, including patents and non-patent publications are hereby incorporated herein by reference in their entireties.

What I claim is:

1. An arrow tip comprising:
a tip body having an outer wall extending about a central axis;
a point at a front end providing a tapering inward of the outer walls towards the central axis to an apex on the central axis, wherein the point is formed from a plurality of faces joined at circumferentially abutting edges, the faces and edges extending about the axis in a helical path; and
a threaded attachment at a rear end extending along the axis to receive a second threaded attachment on an arrow shaft and to releasably attach the arrow tip to the arrow shaft by rotationally threading the threaded attachment on the second threaded attachment.

2. The arrow tip of claim 1, wherein the apex is a point of convergence of the helical faces and edges.

3. The arrow tip of claim 1, wherein the helical faces and helical edges run counterclockwise with respect to the central axis of the tip body viewed from the front end.

4. The arrow tip of claim 1, wherein the faces are hollow ground.

5. The arrow tip of claim 1, wherein the faces are concave in a plane perpendicular to the central axis.

6. The arrow tip of claim 1, wherein the circumferentially abutting edges meet at an angle of less than 50 measured with respect to a plane perpendicular to the central axis.

7. The arrow tip of claim 1, wherein there are between three and six faces.

8. The arrow tip of claim 1, wherein the helical faces and helical edges have a rotational sense relative to the threaded attachment tending to tighten the threaded attachment when the tip passes through a resisting material with the apex in a leading position.

9. The arrow tip of claim 1, wherein the tip is stainless steel.

10. The arrow tip of claim 1, wherein the up body is substantially cylindrical in shape.

11. The arrow tip of claim 1, wherein the tip body may be circumscribed by a cylinder having a diameter of ¼″ to ⅝″.

12. An arrow comprising:
an elongate shaft extending along a linear axis;
as nock attached at a rear end of the elongate shaft and providing a groove extending in a plane including the linear axis to receive a bow string;
an adapter attached at a front end of the shaft distally from the nock along the linear axis, wherein the adapter provides at its front end a first threaded attachment;
a tip, wherein the tip comprises:
a tip body having an outer wall extending about a central axis;
a point at the front end providing a tapering inward of the outer walls towards the central axis to an apex on the central axis, wherein the point is formed from a plurality of faces joined at circumferentially abutting edges, the faces and edges extending about the axis in a helical path; and
a threaded attachment at the rear end extending along the axis to receive a second threaded attachment on an arrow shaft and to releasably attach the arrow tip to the arrow shaft by rotationally threading the threaded attachment on the second threaded attachment.

13. The arrow of claim 12, further including at least one arrow barb, wherein the barb is attached to the adapter and wherein the at least one barb pivots with respect to the adapter;
wherein the at least one arrow barb is attached to the adapter are able to pivot about an axis perpendicular to the arrow axis and wherein a front edge of the at least one barb abuts a rear face of the arrow tip and is prevented from pivoting past perpendicular while the arrow tip is attached to the arrow.

14. The arrow of claim 13, wherein the at least one arrow barb is able to pivot substantially past perpendicular toward the tip only after the arrow tip is loosened or removed,

15. A method of manufacturing an arrow tip wherein the arrow tip comprises:
a tip body having an outer wall extending about a central axis;
a point at a front end providing a tapering inward of the outer walls towards the central axis to an apex on the central axis, wherein the point is formed from a plurality of faces joined at circumferentially abutting edges, the faces and edges extending about the axis in a helical path, and
a threaded attachment at a rear end extending along the axis to receive a second threaded attachment on an arrow shaft and to releasably attach the arrow tip to the arrow shaft by rotationally threading the threaded attachment on the second threaded attachment;
the method comprising the steps of
utilizing a cutting tool having a cutting surface that rotates about an axis parallel to a central axis of a tip body;
rotating the cutting tool within a plane about an axis parallel to a central axis of a tip body;
translating the plane of the cutting tool along a taper path of the tip body to remove material from the tip body; and
rotating the tip body during the translation, wherein the tip body is rotated between two and 30 degrees.
